(19) United States
(12) Patent Application Publication
(10) Pub. No.: US 2012/0175847 A1
(43) Pub. Date: Jul. 12, 2012

(54) SUPPORT WAVE STOPPER IN WEB AREA OF MULTI-LAYERED STEEL CYLINDER HEAD GASKET

(76) Inventors: Frank W. Popielas, Plainfield, IL (US); Martin M. Mockenhaupt, Buffalo Grove, IL (US); Paul M. Fatora, Woodridge, IL (US); Colin C. Chen, Barrington, IL (US)

(21) Appl. No.: 13/004,940

(22) Filed: Jan. 12, 2011

(51) Int. Cl. F02F 11/00

(52) U.S. Cl. 277/592; 277/595

(57) ABSTRACT

A cylinder head gasket seals combustion chamber openings with two exterior active sealing layers and a central spacer layer. In web areas between adjacent combustion openings, each opening beginning of the active layers has a land, where a circumferential main stopper is formed with the central spacer layer between the lands. Each active layer further has longitudinal waves formed with the active layer which, when compressed, form a longitudinal support wave stopper(s) in the web areas. Each web area active layer further has a full bead(s) in contact with the central spacer layer. For each exterior layer, in one case, two beads come together to form a single central web area bead that separates two wave stoppers. In another case, the two outer bead portions come together upon entering the central web area while a single wave stopper is formed between the two inner bead portions.

### FIELD OF THE INVENTION

The present invention relates to a multi-layered steel cylinder head gasket. More particularly, the present invention relates to a multi-layered steel cylinder head gasket having a support wave stopper in a web area between combustion openings in the cylinder head gasket.

### BACKGROUND OF THE INVENTION

Those skilled in the art appreciate the issues involved in maintaining a high quality seal between combustion openings in a cylinder head gasket for a cylinder block in an internal combustion engine with a cylinder head fastened to the cylinder block. In recent years, multi-layered steel (MLS) cylinder head gaskets (CHG) have become a preferred design choice, wherein all gasket layers (typically three) have been formed of steel. Beaded exterior layers have generally been fabricated of 301 stainless steel, a relatively robust metal with a high spring rate for meeting requisite performance requirements over a useful gasket life span. The center layer, also called a “spacer” layer, has generally been formed of less robust metals, such as 409 stainless steel, or in some cases even zinc-plated or plain low carbon steels, for meeting less rigorous operating requirements.

Further, it is known that areas immediately adjacent circumferential edges of combustion openings are subjected to considerably greater stresses than areas of the gasket radially remote from the openings. The circumferential edges are more difficult to seal because of the greater stresses. In order to meet the greater stress requirements at combustion openings, so-called stopper layers have been employed circumferentially around each combustion opening. The stopper layers are purposefully designed to provide increased sealing pressures around the noted combustion openings. In some cases, these stoppers have been formed of extra layers of metal, consisting either of layers folded over or under primary sealing layers. In other cases, the stoppers have been formed as layers separately provided, e.g., discrete annular rings positioned about the opening boundaries.

In addition, embossed resilient sealing beads are employed in duplicate mirror image exterior sealing layers. However, in some instances, beaded exterior sealing layers have been prone to cracking at the boundaries of the beads, particularly in narrow web areas between combustion openings. In such small areas, high stress dynamics can create stresses on the beads that can exceed bead deflection stress capabilities. Resultant cold working and associated bead cracking are issues seriously detrimental to both the performance and longevity of gaskets that otherwise provide reliable combustion sealing media.

In some current MLS CHG designs, a main stopper has a feature of a beaded spacer layer. In heavy-duty applications, the web areas of such cylinder head gaskets may become very hot with a large temperature gradient to the other areas of the gaskets. This temperature gradient might create, in the web area, much more thermal expansion than in other areas. Such thermal expansion results in an additional loading on the combustion seal in the web area, which may result in a thermal crush that exceeds the load limiting capabilities in the web, area of the main stopper. Thus, the cylinder head gasket would start to leak or the full bead of the active sealing layer would crack. Therefore, additional load limiting capabilities are needed for these conditions.

An example of cylinder head gasket art is U.S. Pat. No. 4,998,741 to Udagawa which discloses a metal plate used as a cylinder head gasket having at least one dividing area (i.e., web area) between each of two cylinder holes. The metal plate is provided with a reinforcing bead, which is unfilled and situated in the dividing area extending in a longitudinal direction between the two cylinder holes. As the metal gasket is compressed between the cylinder block and cylinder head, a plurality of beads are formed from the single bead to seal between adjacent cylinder holes. The '741 patent also discloses a reinforcing bead arrangement for a steel laminate gasket having multiple metal plates where the reinforcing bead is present in only one metal layer. Unfortunately, it has been found that Udagawa's reinforcing bead arrangement would be inadequate in engines where a filled bead might be over crushed.

Further, U.S. Pat. No. 5,669,614, also to Udagawa, discloses a metal gasket having an inner bead surrounding each combustion opening and an outer bead surrounding the same. The outer bead is interrupted at the bolt holes, in the web area between the combustion holes, to affect surface pressure on the gasket at the bolt hole. The outer bead, however, follows the contour of the combustion opening and does not fill the void in the web area dividing each combustion opening. For this Udagawa gasket, the radially outer bead is removed at the bolts in order to increase the crush (thereby the loading) of the inner sealing bead.

U.S. Pat. No. 7,293,779 to Inciong teaches a metal gasket that is particularly designed for heavy duty racing engines which produce more severe conditions that could cause such a gasket to fail. This patent teaches a foldover stopper in the web area that is circumferentially disposed around the engine combustion openings and then through the web areas between the engine combustion openings. Unfortunately, such a stopper will crack in applications requiring a thick spacer layer.

Even with these means of preventing failures in web areas, an MLS CHG is sought that can better protect against ever increasing applications of extreme conditions in web area MLS gaskets. As mentioned above, since the thermal crush may exceed the load limiting capabilities in the web area of the main stopper, additional load limiting capabilities are needed in the web area.

### SUMMARY OF THE INVENTION

A cylinder head gasket comprises an upper active metal layer that has an outer surface and an inner surface, where the upper active metal layer comprises a first land having a beginning from a first combustion opening and extending into a web area. The upper active metal layer further comprises a second land having a beginning from a second combustion opening and extending into the web area. There is at least one concave upper full bead unitarily formed with the upper active layer between the upper lands. There is at least one upper wave stopper which is comprised of a plurality of crests and troughs and is unitarily formed with the upper active metal layer between the upper lands.

The cylinder head gasket further comprises a lower active metal layer that has an outer surface and an inner surface, where the lower active metal layer comprises a first land having a beginning from the first combustion opening and extending into the web area. The lower active metal layer further comprises a second land having a beginning from the second combustion opening and extending into the web area. There is at least one concave lower full bead unitarily formed with the lower active layer between the lower lands. There is at least one lower wave stopper which is comprised of a plurality of crests and troughs and is unitarily formed with the lower active metal layer between the lower lands.

The cylinder head gasket further comprises a metal spacer layer having an upper surface and a lower surface, where the spacer layer is located between the upper active metal layer and the lower active metal layer. The inner surface of the upper active metal layer, at the upper full bead, contacts the upper surface of the spacer layer. The inner surface of the lower active metal layer, at the lower full bead, contacts the lower surface of the spacer layer.

A first main beaded stopper is unitarily formed with the metal spacer layer and is in contact with the lower surface of the upper active metal layer directly beneath the upper first land. A second main beaded stopper is unitarily formed with the metal spacer layer and is in contact with the lower surface of said upper active metal layer directly beneath the upper second land, wherein each of the stoppers is circumferentially formed around a corresponding combustion opening.

### BRIEF DESCRIPTION OF THE DRAWINGS

The above, as well as other advantages of the present invention will become readily apparent to those skilled in the art from the following detailed description when considered in the light of the accompanying drawing in which:

FIG. 1 is a top view of a portion of a first embodiment of an MLS cylinder head gasket in accordance with the present invention;

FIG. 1A is a cross-sectional side view in the direction of the arrows 1A-1A of the MLS cylinder head gasket of FIG. 1;

FIG. 1B is a cross-sectional side view in the direction of the arrows 1B-1B of the MLS cylinder head gasket of FIG. 1;

FIG. 2 is a cross-sectional side view in the direction of the arrows 2-2 of the MLS cylinder head gasket of FIG. 1;

FIG. 3 is a top view of a portion of a second embodiment of an MLS cylinder head gasket in accordance with the present invention;

FIG. 3A is a cross-sectional side view in the direction of the arrows 3A-3A of the MLS cylinder head gasket of FIG. 3;

FIG. 3B is a cross-sectional side view in the direction of the arrows 3B-3B of the MLS cylinder head gasket of FIG. 3; and FIG. 4 is a cross-sectional side view in the direction of the arrows 4-4 of the MLS cylinder head gasket of FIG. 3.

### DETAILED DESCRIPTION OF THE INVENTION

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

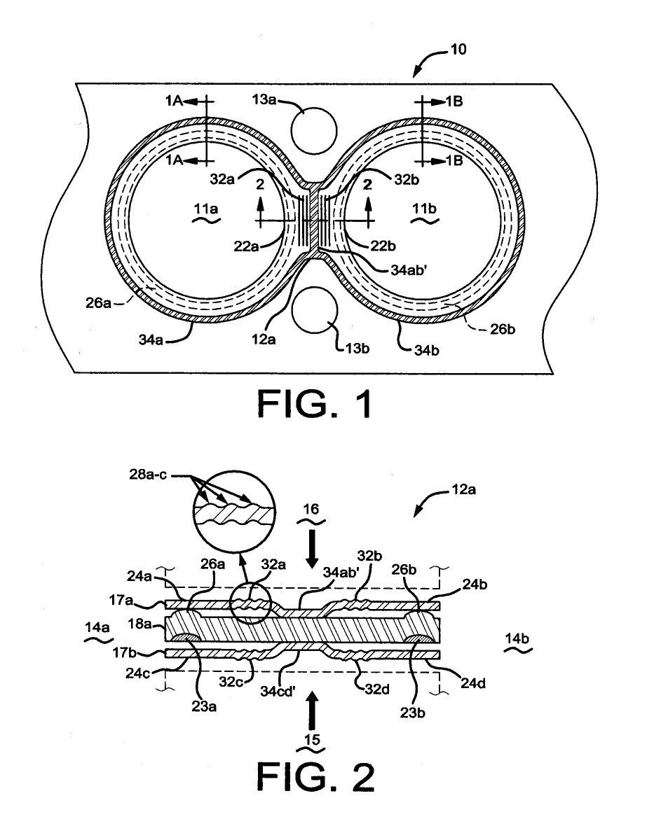

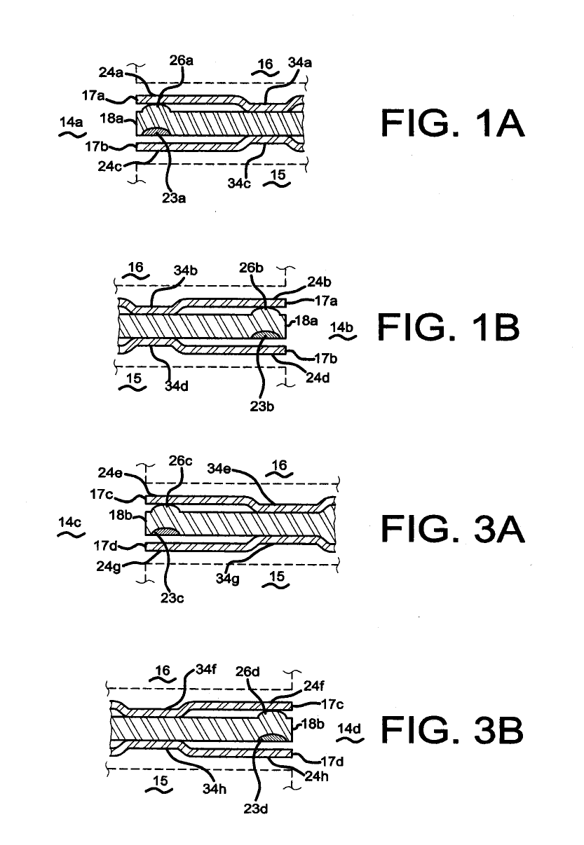

A cylinder head gasket has a plurality of combustion openings, where FIGS. 1, 1A, 1B, and 2 illustrate a portion of a particular embodiment of the cylinder head gasket 10 that has two adjacent combustion openings 11a, 11b which are separated by a web area 12a, where a web area refers to a thin connecting region between adjacent combustion openings. In general, the gasket 10 is used to seal about corresponding combustion chambers 14a, 14b, while being compressed between a cylinder block 15 and a cylinder head 16, which are shown in dashed lines coming together (see dark arrows) just prior to being bolted together, in an internal combustion engine (not shown).

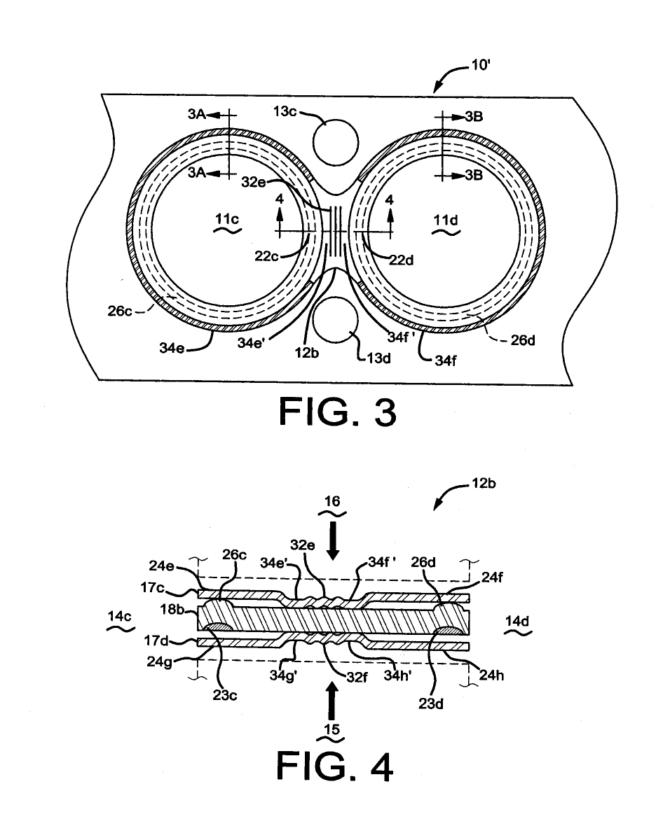

The cylinder block 15 and cylinder head 16 are bolted together by bolts (not shown), which utilize bolt holes 13a-d (as shown in FIGS. 1 and 3) that are disposed in corresponding cylinder head gaskets 10, 10′ in a manner commonly known in the art. Although FIGS. 1 and 3, respectively, show only two adjacent combustion openings 11a, 11b, the cylinder head gaskets 10, 10′ typically have additional adjacent openings, with corresponding lands, beads, and wave stoppers. The cylinder head gasket 10 comprises two exterior metal active sealing layers 17a, 17b, which may be mirror images of each other, with at least a central metal spacer layer 18a therebetween. The active sealing layers 17a-d (see FIGS. 2 and 4), including the portion of the layers within web areas 12a-b, may be fabricated of 301 stainless steel and the spacer layers 18a-b, including the portion of the layers within web areas 12a-b, may be fabricated of 409 stainless steel.

In the web area 12a, between adjacent land beginnings 22a, 22b of corresponding adjacent openings 11a, 11b, the left viewed sides of the exterior metal active sealing layers 17a, 17b have lands 24a, 24c above/below a main beaded stopper 26a which is circumferentially and unitarily formed (which may be directly) with the central metal spacer layer 18a, about the combustion opening 11a. The main beaded stopper 26a may be back filled with a hard coating 23a disposed therein. Hard coatings 23a-d may comprise an elastic-plastically deformable material. This material is compressible and gas-tight which can be produced, e.g., from a composite of a synthetic resin and a metal powder or minerals, such as H11 filled bead ceramics, as described in U.S. Pat. No. 6,712,364 and DE Patent 199 28 580 (which are incorporated herein in their entirety).

Similarly, the right viewed sides of the exterior metal active sealing layers 17a, 17b have lands 24b, 24d above/below a main beaded stopper 26b which is circumferentially and unitarily formed (which may be directly) with the central metal spacer layer 18a, about the combustion opening 11b. The central metal spacer layer 18a, between the beads 26a, 26b, may have a substantially constant thickness.

In general, a discovery of the present invention is the forming of at least one wave stopper in a web area of a cylinder head gasket. Specifically, for this embodiment, the exterior metal active sealing layers 17a, 17b are shown in the web area 12a with corresponding longitudinal support wave stoppers 32a, 32b and 32c, 32d which are unitarily formed therewith. All of the wave stoppers 32a-f shown in FIGS. 1-4 comprise individual sets of longitudinal waves (i.e., crests and troughs) in much the same way as the three individual crests/troughs 28a-c of the longitudinal support wave stopper 32a, which is specifically shown in the inset of FIG. 1.

The support wave stoppers 32a-f, however, may comprise varying numbers of waves other than three. The longitudinal support wave stoppers 32a, 32b and 32c, 32d of FIGS. 1-2 are formed with respective exterior metal active sealing layers 17a, 17b by compressing the waves, like the longitudinal waves 28a-c, between the cylinder head 16 and the cylinder block 15. This process of forming the wave stopper 32a is the same for all of the other wave stoppers 32b-e.

The wave stoppers 32a, 32c and 32b, 32d of the upper/lower active metal layers 17a, 17b may be axially aligned with one another. The wave stoppers 32a, 32b of the upper active metal layer 17a may be longitudinally aligned with one another and the wave stoppers 32c, 32d of the lower active metal layer 17b may be longitudinally aligned with one another.

In general, for each of the exterior active sealing layers 17a, 17b there is shown in FIGS. 1-2 that the cylinder head gasket 10 further has two sets of two concave full beads 34a, 34b and 34c, 34d. The beads 34a and 34b and 34c and 34d, respectively, come together at the center of the web area 12a to form the single concave beads 34ab′, 34cd′. The single concave beads 34a-d, 34ab′, 34cd′ are unitarily formed, which may be directly, with the corresponding active metal layer 17a and 17b. As such, the inner surface of the upper active metal layer 17a, at the beads 34a, 34b, 34ab′, contacts the upper surface of the spacer layer 18a and the inner surface of the lower active metal layer 17b, at the beads 34c, 34d, 34cd′ contacts the lower surface of the spacer layer 18a.

Specifically, as can be viewed in the center of FIG. 1 for the upper active metal layer 17a of the gasket 10, each of the two upper beads 34a, 34b come together at the top of the web area 12a in the form of a “tee” and then form a single bead 34ab′ at the center of the web area 12a. Then, the single bead 34ab′ separates at the bottom “tee” back into the two circumferentially formed upper beads 34a, 34b around the lower portion of the respective adjacent combustion openings 11a, 11b. Thereby, collectively the upper beads 34a, 34b, 34ab′ are formed in the shape of an eight.

Also, since the lower active metal layer 17b of the gasket 10, which is depicted in FIG. 1, is a mirror image of the upper layer 17a, then each of the two lower beads 34c, 34d come together at the top of the web area 12a in the form of a “tee” and then form a single bead 34cd′ at the center of the web area 12a. Then, the single bead 34cd′ separates at the bottom “tee” back into the two circumferentially formed upper beads 34a, 34b around the lower portion of the respective adjacent combustion openings 11a, 11b. Thereby, collectively the lower beads 34c, 34d, 34cd′ are also formed in the shape of an eight.

FIGS. 1A and 1B, respectively, illustrate cross-sectional plan views in the direction of the arrows 1A-1A and 1B-1B of the MLS cylinder head gasket of FIG. 1. Specifically, FIG. 1A shows the upper bead 34a and the lower bead 34c as full beads in an area of the gasket 10 away from the web area 12a. FIG. 1B shows the upper bead 34b and the lower bead 34d as full beads in another area of the cylinder head gasket 10 away from the web area 12a.

The beads 34a and 34c, 34ab′ and 34cd′, and 34b and 34d may be axially aligned with one another. The beads 34a, 34b, 34ab′ of the upper active metal layer 17a may be longitudinally aligned with one another and the beads 34c, 34d, 34cd′ of the lower active metal layer 17b may be longitudinally aligned with one another.

For a second embodiment of the present invention, FIGS. 3, 3A, 3B, and 4 illustrate a portion a cylinder head gasket 10′ that has two adjacent combustion openings 11c, 11d which are separated by a web area 12b. In general, the gasket 10′ is used to seal about corresponding combustion chambers 14c, 14d, while being compressed between the cylinder block 15 and the cylinder head 16, in much the same manner as described above for the embodiment depicted in FIGS. 1 and 2.

The cylinder head gasket 10′ comprises two exterior metal active sealing layers 17c, 17d, which may be mirror images of each other, with at least a central metal spacer layer 18b therebetween.

In the web area 12b, between adjacent land beginnings 22c, 22d of the corresponding adjacent combustion openings 11c, 11d, the left viewed sides of the exterior metal active sealing layers 17c, 17d have lands 24e, 24g above/below a main beaded stopper 26c which is circumferentially and unitarily formed with the central metal spacer layer 18b, about the combustion opening 11c. The main beaded stopper 26c may be back filled with a hard coating 23c disposed therein.

Similarly, in the web area 12b between adjacent land beginnings 22c, 22d of the corresponding adjacent combustion openings 11c, 11d, the right viewed sides of the exterior metal active sealing layers 17c, 17d have lands 24f, 24h above/below a main beaded stopper 26d which is circumferentially and unitarily formed with the central metal spacer layer 18b, about the combustion opening 11d. The main beaded stopper 26d may be back filled with a hard coating 23d disposed therein. The central metal spacer layer 18b, between the beads 26c, 26d, may have a substantially constant thickness.

Upper and lower support wave stoppers 32e, 32f are formed at the center of the web area 12b, within corresponding exterior metal active sealing layers 17c, 17d, and between respective separate corresponding inner bead portions 34e′, 34f′ and 34g′, 34h′ that are unitarily formed, which may be directly, in the exterior metal active sealing layers 17c, 17d. Outside of the web area 12b, corresponding full beads 34e, 34f and 34g, 34h are circumferentially disposed about the corresponding combustion openings 11c, 11d. As a result, collectively the upper beads 34e, 34f and upper inner bead portions 34e′, 34f′ form an eight, as do the lower beads 34g, 34h and lower inner bead portions 34g′, 34h′. The formation in the shape of an eight could continue between other adjacent openings of a complete cylinder head gasket 10′ have more than two combustion openings 11c, 11d.

In forming these concave beads 34e, 34f, 34g, 34h and inner bead portions 34e′, 34f′, 34g′, 34h′, the respective inner surfaces of the active metal layers 17c and 17d, at the beads 34e-h′, contact the corresponding upper/lower surfaces of the spacer layer 18b.

To summarize, outside of said web area 12b, each of the active metal layers 17c,d comprises two individual full concave beads 34e,f and 34g,h that are circumferentially formed around corresponding combustion openings 11c,d. Within the web area 12b, the two individual full concave beads 34e,f and 34g,h come together at the top and bottom of the web area 12b, where the inner bead portion 34e′,f′, 34g′,h′ of each of the beads 34e,f and 34g,h completes a full circumference around its corresponding combustion opening 11c,d. The outer portion of each of the beads connect together and a single wave stopper 32e,f is located between their corresponding inner portion bead 34e′,f, 34g′,h′.

FIGS. 3A and 3B, respectively, illustrate cross-sectional plan views in the direction of the arrows 3A-3A and 3B-3B of the MLS cylinder head gasket of FIG. 3. Specifically, FIG. 3A shows the upper bead 34e and the lower bead 34g as full beads in an area of the cylinder head gasket 10′ away from the web area 12b. FIG. 3B shows the upper bead 34f and the lower bead 34h as full beads in another area of the cylinder head gasket 10′ away from the web area 12b.

The wave stoppers 32e and 32f of the upper and lower active metal layers 17c, 17d may be axially aligned with one another. Also, the beads 34e, 34g, 34f, and 34h and the bead portions 34e′, 34g′, 34f, and 34h′ may be axially aligned with one another. The beads and bead portions 34e, 34f, 34e′, 34f′ of the upper active metal layer 17c may be longitudinally aligned with one another and the beads and bead portions 34g, 34h, 34g′, 34h′ of the lower active metal layer 17d may be longitudinally aligned with one another.

It has been found that the forming of the longitudinal support wave stoppers 32a-f in the web areas 12a-b of the above-described embodiments 10, 10′ provides added resistance, especially under severe thermal, pressure, and chemical conditions that has not been provided in the past. Essentially, the longitudinal support wave stoppers 32a-f, as described herein, protect the main stoppers 26a-d and prevent the main stoppers 26a-d from being thermally crushed, where the load limit capabilities may become excessive. The longitudinal support wave stoppers 32a-f also prevent possible deterioration of the hard coat fillings 23a-d. Since internal combustion engines of the present and the future are evermore being required to sustain more extreme operating conditions, for example, higher operating temperatures due to alternative fuel mixtures, the above described embodiments are disclosed to meet these requirements.

The number of the waves (like 38a-c) and the longitudinal length of the waves at least depend on the load to be withstood and the space available. Since the longitudinal support wave stoppers 32a-f of the instant invention are made a unitary part of their respective active sealing layers 17a-d, in the web areas 12a-b, and since these stoppers 32a-f do not need much of a force to form them with the active sealing layers 17a-d, then the longitudinal wave stoppers 32a-f are formed along with the beads 34a-d, 34ab′ and 34cd′, and 34e-h, and bead portions 34e′-h′ within the active sealing layers 17a-d. Thus, an advantage of the above-described invention is that it does not require additional material to be incorporated with the active sealing layers 17a-d, like additional full layers or fold over/under layers of past designs, thereby reducing material costs and manufacturing costs.

Also, the fact that the wave stoppers 32a-f, in conjunction with the beads 34a-d, 34ab′ and 34cd′, and 34e-h, and bead portions 34e′-h′, are formed in the stronger outer active sealing layers 17a-d provides the cylinder head gaskets 10, 10′ of the present invention an advantage over prior cylinder head gaskets, with regard to surviving more rigorous conditions in an internal combustion engine.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A cylinder head gasket, comprising:
an upper active metal layer having an outer surface and an inner surface, comprising:
a first land having a beginning from a first combustion opening and extending into a web area;
a second land having a beginning from a second combustion opening and extending into said web area;
at least one concave upper bead unitarily formed directly with said active layer between said lands;
at least one wave stopper comprised of a plurality of crests and troughs unitarily formed with said active layer between said lands;
a lower active metal layer having an outer surface and an inner surface, comprising:
a first land having a beginning from said first combustion opening and extending into said web area;
a second land having a beginning from said second combustion opening and extending into said web area;
at least one concave lower bead unitarily formed directly with said active layer between said lands;
at least one wave stopper comprised of a plurality of crests and troughs unitarily formed with said active layer between said lands;
a metal spacer layer having an upper surface and a lower surface, said spacer layer located between said upper active metal layer and said lower active metal layer, wherein said inner surface of said upper active metal layer, at said upper bead, contacts said upper surface of said spacer layer and said inner surface of said lower active metal layer, at said lower bead, contacts said lower surface of said spacer layer;
a first main beaded stopper unitarily formed with said metal spacer layer and in contact with said lower surface of said upper active metal layer directly beneath said upper first land; and
a second main beaded stopper unitarily formed with said metal spacer layer and in contact with said lower surface of said upper active metal layer directly beneath said upper second land;
wherein each of said main beaded stoppers is circumferentially formed around a corresponding combustion opening.

2. The gasket of claim 1, wherein said lower active metal layer is a mirror image of said upper active metal layer.

3. The gasket of claim 1, wherein each of said lands has a substantially constant thickness.

4. The gasket of claim 1, wherein said active metal layers comprise 301 stainless steel and said spacer layer comprises 409 stainless steel.

5. The gasket of claim 1, wherein said metal spacer layer has a substantially constant thickness, between said first and second main beaded stoppers.

6. The gasket of claim 5, wherein said beaded stoppers are back filled with a hard coating.

7. The gasket of claim 6, wherein said hard coating comprising an elastic-plastically deformable material selected from the group consisting of a synthetic resin, a metal powder, and a ceramic.

8. The gasket of claim 1, wherein each active metal layer has a first wave stopper formed between said first land and a first bead, and has a second wave stopper formed between said second land and a second bead.

9. The gasket of claim 1, wherein each of said active metal layers comprises one full bead circumferentially formed around a corresponding combustion opening that come together in the form of a “tee” with an adjacent combustion opening full bead at the top and bottom of said web area, where the inner portion of each of said beads comes together to form a single bead at the center of said web area, collectively said beads and said inner portions of said beads are formed in the shape of an eight.

10. The gasket of claim 1, wherein outside of said web area, each of said active metal layers comprises two individual full concave beads circumferentially formed around corresponding combustion openings, and within said web area, said two individual full concave beads come together at the top and bottom of said web area, wherein the inner portion of each of said beads completes a full circumference around said corresponding combustion opening, the outer portion of each of said beads are connected together, and a single wave stopper is located between said inner portion of said beads.

11. The gasket of claim 1, wherein said concave beads of said upper and said lower active metal layers are axially aligned with one another, and said wave stoppers of said upper and said lower active metal layers are axially aligned with one another.

12. The gasket of claim 1, wherein said wave stoppers of said upper active metal layer are longitudinally aligned with one another and said wave stoppers of said lower active metal layer are longitudinally aligned with one another.

13. The gasket of claim 1, wherein said concave beads of said upper active metal layer are longitudinally aligned with one another and said concave beads of said lower active metal layer are longitudinally aligned with one another.

14. The gasket of claim 1, wherein said wave stoppers of said upper and said lower active metal layers have the same number of crests with corresponding troughs.

15. The gasket of claim 14, wherein the number of crests is three.

16. A cylinder head gasket, comprising:
an upper active metal layer having an outer surface and an inner surface, comprising:
a first land having a beginning from a first combustion opening and extending into a web area;
a second land having a beginning from a second combustion opening and extending into said web area;
first and second full concave upper beads circumferentially formed around a corresponding combustion opening, while being unitarily formed directly with said active layer;
a first wave stopper unitarily formed directly with said active layer between said first land and said first full concave upper bead; and
a second wave stopper unitarily formed directly with said active layer between said second land and said second full concave upper bead;
wherein each wave stopper comprises of a plurality of crests and troughs and said first and second full concave beads come together in said web area in the form of a “tee” at the top and bottom of said web area, wherein the inner portion of each of said first and second full concave beads come together to form a single bead at the center of said web area, collectively said beads and said inner portions of said beads are formed in the shape of an eight;
a lower active metal layer having an outer surface and an inner surface, comprising:
a first land having a beginning from said first combustion opening and extending into said web area;
a second land having a beginning from said second combustion opening and extending into said web area;
first and second full concave lower beads circumferentially formed around a corresponding combustion opening, while being unitarily formed directly with said active layer;
a first wave stopper unitarily formed directly with said active layer between said first land and said first full concave lower bead; and
a second wave stopper unitarily formed directly with said active layer between said second land and said full second concave lower bead;
wherein each wave stopper comprises of a plurality of crests and troughs and said first and second full concave beads come together in said web area in the form of a “tee” at the top and bottom of said web area, wherein the inner portion of each of said first and second full concave beads come together to form a single bead at the center of said web area, collectively said beads and said bead portions are formed in the shape of an eight;
wherein said lower active metal layer is a mirror image of said upper active metal layer;
a metal spacer layer having an upper surface and a lower surface, said spacer layer located between said upper active metal layer and said lower active metal layer, wherein said inner surface of said upper active metal layer, at said upper single bead at the center of said web area, contacts said upper surface of said spacer layer and said inner surface of said lower active metal layer, at said lower single bead at the center of said web area, contacts said lower surface of said spacer layer;
a first main beaded stopper unitarily formed with said metal spacer layer and in contact with said lower surface of said upper active metal layer directly beneath said upper first land; and
a second main beaded stopper unitarily formed with said metal spacer layer and in contact with said lower surface of said upper active metal layer directly beneath said upper second land;
wherein each of said main beaded stoppers is circumferentially formed around a corresponding combustion opening.

17. A cylinder head gasket, comprising:
an upper active metal layer having an outer surface and an inner surface, comprising:
a first land having a beginning from a first combustion opening and extending into a web area;
a second land having a beginning from a second combustion opening and extending into said web area;
first and second full concave upper beads circumferentially formed around corresponding said combustion openings, while being unitarily formed directly with said active layer; and
a wave stopper unitarily formed directly with said active layer at the center of said web area, said wave stopper comprised of a plurality of crests and troughs;
wherein said first and second full concave beads come together in said web area at the top and bottom of said web area, wherein the inner portion of each of said first and second full concave beads are separated from each other at the center of said web area by said wave stopper, collectively said beads and said inner portions of said beads are formed in the shape of an eight;
a lower active metal layer having an outer surface and an inner surface, comprising:
a first land having a beginning from a first combustion opening and extending into a web area;
a second land having a beginning from a second combustion opening and extending into said web area;
first and second full concave lower beads circumferentially formed around said corresponding combustion openings, while being unitarily formed directly with said active layer; and
a wave stopper unitarily formed directly with said active layer at the center of said web area, said wave stopper comprised of a plurality of crests and troughs;
wherein said first and second full concave beads come together in said web area at the top and bottom of said web area, wherein the inner portion of each of said first and second full concave beads are separated from each other at the center of said web area by said wave stopper, collectively said beads and said inner portions of said beads are formed in the shape of an eight;
wherein said lower active metal layer is a mirror image of said lower active metal layer;
a metal spacer layer having an upper surface and a lower surface; said spacer layer located between said upper active metal layer and said lower active metal layer, wherein said inner surface of said upper active metal layer, at said inner portion of each of said first and second full concave beads separated by said wave stopper, contacts said upper surface of said spacer layer and said inner surface of said lower active metal layer, at said inner portion of each of said first and second full concave beads separated by said wave stopper, contacts said lower surface of said spacer layer;
a first main beaded stopper unitarily formed with said metal spacer layer and in contact with said lower surface of said upper active metal layer directly beneath said upper first land; and
a second main beaded stopper unitarily formed with said metal spacer layer and in contact with said lower surface of said upper active metal layer directly beneath said upper second land;
wherein each of said main beaded stoppers is circumferentially formed around a corresponding combustion opening.
